(19) United States
(12) Patent Application Publication
(10) Pub. No.: US 2003/0069716 A1
(43) Pub. Date: Apr. 10, 2003

(54) System & method for performing field inspection

(76) Inventor: David Frederick Martinez, Cypress, TX (US)

Correspondence Address: David F. Martinez, ATSER, 1150 Richcrest Drive, Houston, TX, 77060, US

(21) Appl. No.: 09/973,616

(22) Filed: Oct. 9, 2001

(51) Int. Cl. G06F 15/00

(52) U.S. Cl. 702/188

(57) ABSTRACT

A field inspection system includes a handheld computer; a camera coupled to the computer to capture an image or video; a sketch pad coupled to the handheld computer to capture a sketch; and code to annotate the image and to communicate the image to a remote computer.

### BACKGROUND OF THE INVENTION

The present invention generally relates to a civil field inspection system and method

The construction inspection industry is divided into three basic parts; 1) project management, 2) field workmanship and 3) laboratory testing. These areas are monitored, inspected and included in the process of verification of the contractor compliance with plans and specification.

Traditionally, project managers have been using spreadsheets, databases, and other software tools for years in order to track the information they need to run their jobs. Much of that information is originally accumulated in file folders and manual logs. A significantly large amount of information is created and used during a life-cycle of a construction project (i.e., from a planning stage through design and construction stages to facility management).

The administration for the most part is handled through the use of spreadsheets and other limited programs. The field collection is basically performed by paper and transmitted into the administration system. This enables the project schedule, cost and quality to be managed. However it does not happen in real time.

Various computer systems (e.g., CAD system, analytical system, analytical system, simulation system, etc.) have been developed and introduced by construction firms. However, many of these systems are effective only within certain narrow application domains so that transmission of information between different domains is realized by linking together the applications.

To illustrate, in order to accomplish such a construction project, each person in charge shares the project data with others, and keeps such data for his own use, and based on his allotted share of the work. However, the project activities are interrelated with each other in a complex manner so that it is very difficult for the persons in charge to have information in common with each other. Such complexity is because the project data is stored, retrieved, computed and updated as the project progresses from the viewpoint of each person in charge with respect to each particular piece of information.

Although computerized spreadsheets and databases offered significant productivity gains in modeling complex data, none was as intuitive to use as the old, but familiar paper and pencil. To use the new technology, the user had to type information into the cells of the spreadsheet. In the hand of inexperienced users, the data entry aspect was unpleasant. Further, the verification for correct data entry was time consuming. Additionally, the user had to master many complex and arbitrary operations. Furthermore, conventional computerized spreadsheets and databases still required users to manually enter the information.

### SUMMARY

A field inspection system includes a handheld computer; a camera coupled to the computer to capture an image or video; a sketch pad coupled to the handheld computer to capture a sketch; and code to annotate the image and to communicate the image to a remote computer.

Implementations of the system may include one or more of the following. The handheld computer collects work in progress data such as project and contract identification, inspector identification, item number, location, and one or more description of activities. The the handheld computer collects labor related information such as labor type, quantity and hours. The handheld computer also collects equipment information such as equipment type, quantity, hours in use and stand-by hours. The handheld computer can also collect submittal information such as weather condition, comments, and an inspector name. The handheld computer sends collected information to a server. The collected information may be sent wirelessly using a wireless handheld unit. Alternatively, a modem coupled to the handheld computer can be used to transmit the information. Also, a hot-sync cradle coupleable to the handheld computer can be used for hot-syncing the collected information for transmission to a server.

Advantages of the system may include one or more of the following. The system takes the industry to another level by making the process paperless. The field and laboratory testing is collected electronically. The inspection and testing data is transported electronically. This new technique will allow the entire process to be monitored in near real time. The project manager can basically manage the project cost, schedule and quality in near real time. The system manages the construction of multiple projects using inexpensive handheld computers communicating with a server. The handheld computer stores daily field journals such as work progress of unit bid items and contract deliverables, manpower utilization, equipment utilization, and general information including weather, temperature, remarks, and the inspector's name. The handheld computer also captures an inspection checklist and generates Punch list items, tracks Punch list items, takes facility inventory, and tracks facility repairs and cost estimates. The handheld also handles project documentation, such as project specifications, industry specifications, and drawing logs, among others.

The system is an integrated program management system where the processes for planning process, designing and constructing operations share the same information. The system can also perform program management where a large construction program can have a plurality of projects within that program. The system can manage the process of planning long range budget plans and after the plans have been approved, the system can specify for a particular year the projects that are in a design phase where an architect or engineering firm performs initial site feasibility studies, performs the design work so that the project can receive bids from construction companies. The system can also provide project tracking on a day to day basis. The tracking can be done using an inspection system field notebook system that tracks the progress of the project on a day to day basis as well as values that are paid to the contractor so that correct intermediate progress payments can be made for a particular project.

The system is as easy to use as the pen and paper approach and provides information integration advantages, including the ability to capture data from scanners, barcode readers, or the Internet. Furthermore, as portable computers are typically deployed in field applications by service providers where employees are scattered over a wide geographic area, the information advantages arising from integrating data collected from handheld computers include an ability to link information generated at the client's site with follow-up discussions and letters necessary to close the transaction enhances the efficiency of field personnel. The handheld computer is small and inexpensive. Thus, field personnel can perform data collection without carrying a relatively bulky laptop or notebook computer.

Other advantages of the invention may include one or more of the following. The system provides an efficient, integrated system for keeping track of job details that are constantly changing. The management of proposal submittals becomes convenient. Further, the tracking submittal responses or approvals is streamlined. The submittals, transmittals, change orders, request for information, meeting minutes, daily reports, activity logs, and other job related documents are organized and instantly searchable. The system enables information related to a building production to be managed unitarily by making use of a computer and to properly transmit production information generated at each stage of the production to the next process. The field-based project managers can be constantly in touch with the main office via phone, fax, or courier to ensure that their job information is accurate and up-to-date. Production and cost information from the system can be sent directly to the accounting staff for entry into the job costing and accounting software. Further, the system avoids requiring duplicate entries to be made.

### BRIEF DESCRIPTION OF THE DRAWINGS

FIGS. 1A-1B are processes associated with a field inspection system.

FIG. 2 is a diagram illustrating a networked computer system for handling an integrated construction management system.

FIG. 3 is a diagram illustrating major modules associated with an integrated construction management system.

FIG. 4 is a diagram illustrating a system for handling information updates from field personnel.

FIG. 5 is a diagram illustrating a planning-design-construction process flow.

FIG. 6 is a diagram illustrating processing of a capital improvement plan.

FIGS. 7a-7c are flowcharts illustrating two design phases.

FIG. 8 is a diagram illustrating one sequence of processing data in an integrated construction management system.

FIG. 9 is a diagram of an exemplary handheld computer to collect field data.

FIG. 10 is a flowchart illustrating operations performed on the handheld computer of FIG. 9.

### DESCRIPTION

Referring now to FIGS. 1A-1B, processes to perform field inspection are shown. The process 10 supports field data capture using a handheld computer 3 that includes a camera 5 to capture video and a sketchpad to capture a sketch. The process 10 also supports communications between a server 2 and the handheld computer 3.

The process 10 first initializes the handheld computer 3 (step 50). The process then selects a file associated with the current project and brings up the data on screen (step 52). Next, the user performs the civil field inspection (step 53). During this process, the user can use the sketchpad to sketch potential problems or simply to annotate comments (step 54). The user can also send comments and revisions to the service providers based on the progress and the costs. Alternatively, all parties can teleconference over the Internet or over conventional telephone connections (step 55). Alternatively, the user can capture an image or a video of the construction project using the camera (step 56).

If the handheld computer 30 includes a wireless modem, periodically, the service providers upload text annotation, sketch annotation, individual images or video clips of the construction progress to the server (step 58). The images can be compressed using an industry standard format such as JPEG or GIF, while the video clip can be compressed using MPEG, among others. Alternatively, other techniques such as sound bites describing a walk through of the remodeling progress can be uploaded in lieu of the images or video clips.

FIG. 1B shows a process for viewing the data uploaded by the handheld computer 30 to the server 20. A user such as a project manager can periodically log-on to the server to view the progress of the construction (step 60). The images may be played one at a time (step 62) or in sequence to show a movie detailing the construction progress (step 64).

FIG. 2 illustrates an exemplary hardware configuration system 110 for executing the modules of FIG. 1. In the system of FIG. 2, one or more mobile computers 112, 114 and 116 are carried by one or more inspectors. The mobile computers 112, 114 and 116 are connected to a dialup network 120. The data transfers can be performed using this dial-up network or directly from local area network at the main office. Specifically, the dialup network can simply be the Plain Old Telephone Service (POTS) network. Each mobile computer executes a field inspection software that communicates with a camera coupled to the computer to capture video, a sketch pad coupled to the handheld computer to capture a sketch. Each mobile computer also contains code to communicate the video and sketch with a remote user such as a project manager.

The dialup network 120 in turn is connected to a server 130 which is protected by a firewall. The firewall is a security system (hardware and/or software) that isolates resources of a computer system or network from objects outside of the system or network. Generally, the firewall allows for inside objects to request and receive connections to outside objects (e.g. for inside applications to access outside Internet sites, among others), but prevents outside applications from accessing resources inside the system or network.

Some firewalls permit only email traffic through them, thereby protecting the network against any attacks other than attacks against the Email service. Other firewalls provide less strict protections, and block services that are known to be problems. Generally, firewalls are configured to protect against unauthenticated interactive logins from the “outside” world. This, more than anything, helps prevent vandals from logging into machines on the user's network. More elaborate firewalls block traffic from the outside to the inside, but permit users on the inside to communicate freely with the outside.

The server 130 is connected to one or more contract databases 132, 134, 136, and 138. The server 130 also is connected to a master server 140. The master server 140 is connected to one or more master databases 142, 144, and 146. The master server 140 is also connected to one or more workstations, including a project manager workstation 150, a project engineering workstation 152, and an estimator workstation 154.

In this implementation, the master server 140 can be a plurality of redundant, fail-over servers, where each server can provide resources independent of the other until one of the servers fails. Each server continuously monitors the other server. In one implementation, server processes available from Microsoft Corp. of Redmond, Wash. called Microsoft Cluster Server (MSCS) uses a hot-standby technique in which a primary server and a standby server send “keep alive” messages back and forth so that the standby server is activated if it cannot contact the primary server. When one of the servers fails, the surviving server acquires the shared drives and volumes of the failed server and mounts the volumes contained on the shared drives. Applications that use the shared drives can also be started on the surviving server after the failover. Further, a manual-failover operation can be performed on the shared volumes at any time in order to perform tasks such as scheduled maintenance on one of the servers. As soon as the failed server is booted up and the communication between servers indicates that the server is ready to own its shared drives, the servers automatically start the recovery process.

The databases 142-146 can reside on one or more network RAID data storage devices. In such an embodiment, the network RAID data storage device is a collection of disks under hardware or software control so that a single drive failure does not bring the system of FIG. 1 down. The data storage devices may be a RAID-1 system, in which every disk has a mirror image of its data stored on another disk. Alternatively, the data storage devices may be a RAID-2 or RAID-3 sub-system which stripes user data across a group of data drives (typically four or eight drives per group). The data storage devices may also be a RAID-4 or RAID-5 sub-system which stripes block (or sometimes groups of blocks) of data and stores the data entirely on an individual disk.

Referring now to FIG. 3, major modules associated with the system of FIG. 2 is shown. In FIG. 3, a field journal 162 is maintained on an inspector portable computer 164. The inspector portable computer 164 communicates with a firewall server 166. The firewall server 166 in turn communicates with a main server 170.

A plurality of modules are in turn are executed on the main server 170. The modules include a new project module 171, a project information module 172, a new contract module 173, a closure module 174 and a search module 175. The new project module 171 creates and initializes database structures for a new project. The project information module 172 provides management and accounting reports associated with a particular project. The new contract module 173 creates and initializes database structures for a new contract. The search module 175 searches for information relating a particular project or contract. The closure module 174 generates various final inspection reports and authorization for final payments. Additionally, the main server 170 executes a key indicator status (KIS) summary status module 176 that tracks the projects in terms of overall dollars and schedule time and provides at a quick glance whether each project is ahead of schedule or over/under budget.

Various reporting modules are also executed on a server 170. These modules include, but are not limited to, a daily report module 167, a monthly report module 168, and an estimate report module 169. Additionally, a change order module 177 performs the document management involved in sending out requests for information and eventually the change orders on a contract.

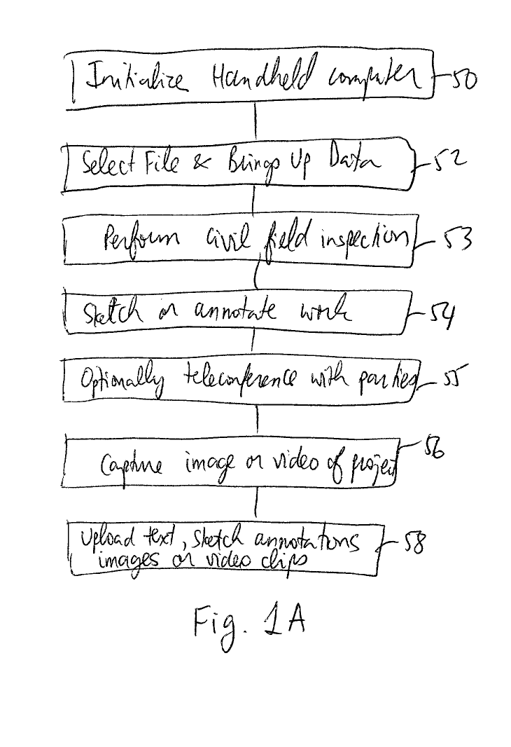

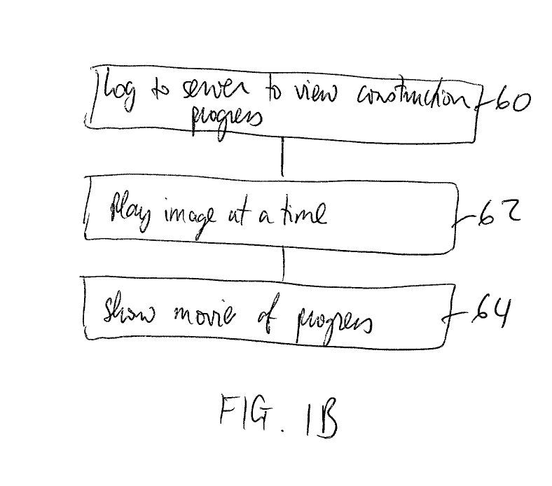

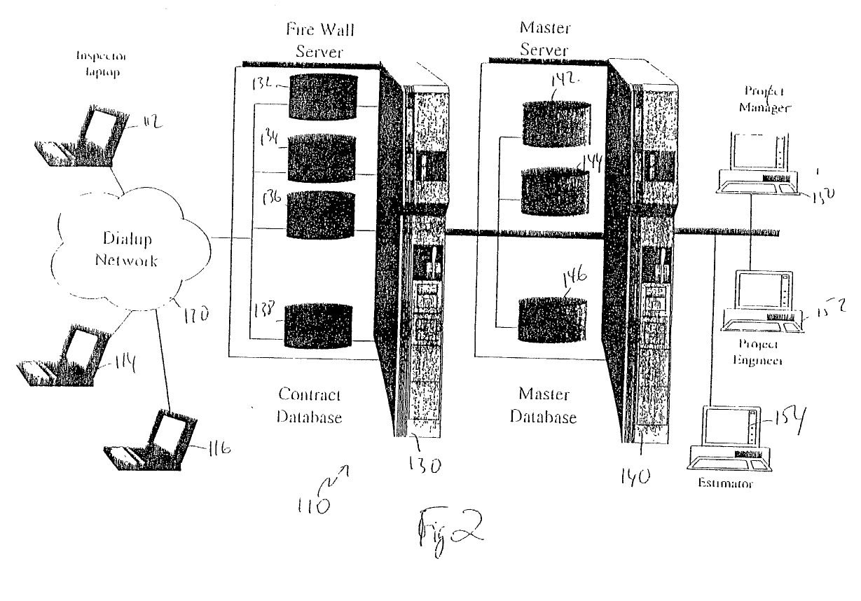

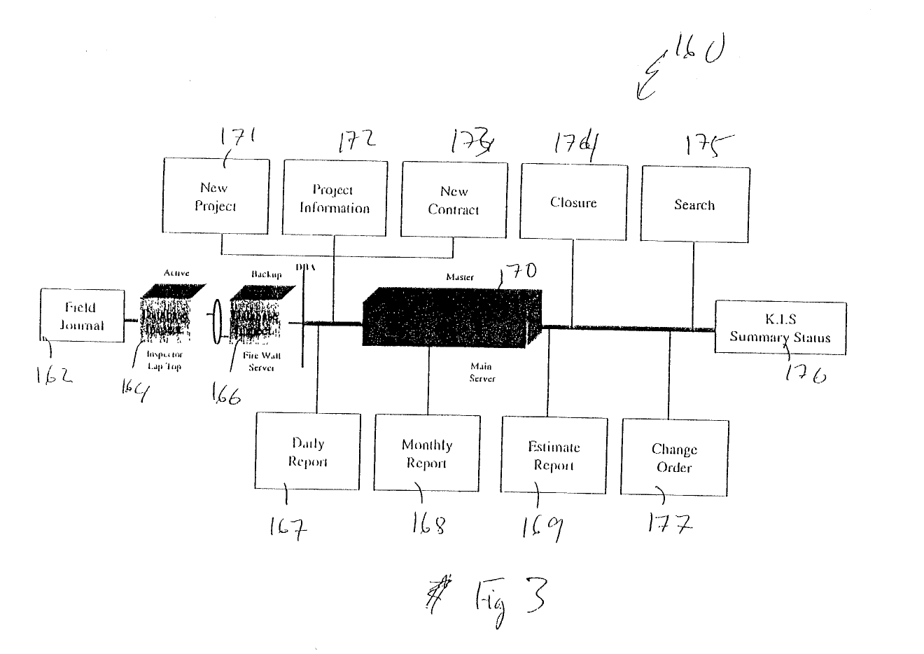

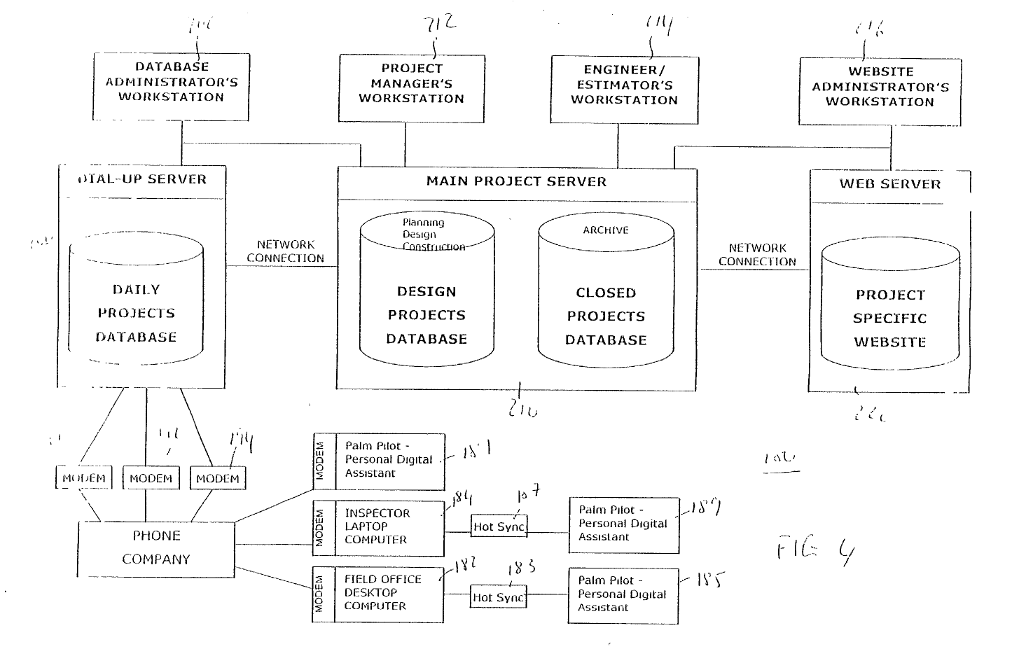

Referring now to FIG. 4, processes executed on the portable computer 164 of FIG. 3 are shown. In FIG. 4, a plurality of inspector portable computers 182, 184, and 186 communicate with a telephone company terminal 188. The terminal 188 can communicate over the POTS network. The terminal 188 is connected to one or more modems 190, 192, and 194. The modems 192 and 194 in turn transfer information to a dialup server 200 which contains a project database. The dialup server 200 communicates with a database administrator workstation 202, which allows a database administrator to maintain and operate the various databases. The dialup server 200 also communicates through a network connection to a main project server 210 which contains a planning design and construction project database. The server 210 also contains an archival database for all closed projects. The main project server 210 also communicates with a project manager workstation 212 and an engineering/estimator workstation 214. The main project server 210 also communicates with a web site administrator workstation 216 which allows an administrator to manage the web site. The main project server 210 also communicates through the network connection to a web server 220. The web server 220 contains one or more project specific web sites so that the sites can be publicly accessed using the Internet. The web server 220 and the project-specific web site can host the reports generated from the Integrated Construction Project Management System (ICPMS) by saving to a specific folder related to each individual project. The project specific web site can be secured so that only people associated with the project can see reports from the web site.

The daily projects database contains folders with database files associated with a particular project. After initializing the construction database and performing a new project set up, a resident engineer or a field inspector posts daily reports or daily field journals which track on a daily basis the progress of the work. Each day, the inspector downloads a subset of the master database from the contract database that would only include the project information related to the projects being reviewed that day. At the end of the day, each inspector updates information for his reviewed project(s) and uploads or transmits that information back to the daily project folders in the contract database.

A field inspector can select the projects that he or she is interested in uploading and downloading. The uploading/downloading processes populate databases on the firewall server. A project estimator initially sets up a project folder. If a new project is uploaded to a folder on the firewall server network, a unique project folder is created on the dialup server with the following naming convention: a file folder name that correlates to the project number and an assigned contract number and uploads project data into the project folder. If the project already exists, the system simply copies the project data into a new project folder on the server network.

Subsequently, the inspector sets up a dialup connection, logs-in with the appropriate authorization, and invokes an upload/download menu. The inspector selects a new project that's on the list and downloads information associated with the selected project to his laptop or portable computer. The information includes data on costs, schedules, bid items, and change orders, among others. Once downloaded, the inspector can update the bid item quantities delivered and field progress information for the project. At the end of the day, the inspector runs a daily field report—daily field journal which includes information on the work performed for that day. The report can also cover a range of days, so that if the inspector has been out on a job all week and has been filling out daily field journals every day, a range of days can be selected for transmission once.

After the firewall server has been updated, the estimator can repopulate the master database to make it current. The estimator connects to this firewall server and selects one or more projects to refresh the master database. The updating the master database is done with a SQL command which keys off of the project number and the contract as the primary keys.

Pseudo-code for the synchronization of project information between the inspector's computer and the server is as follows:

Steps done by the Estimator/DB Administrator

Enters New Project Information into the Master Database

Activates the Upload/Download Menu

Selects the New Project just created

Selects the Send Button

This Creates a unique project folder on the Dial Up Server with the following naming convention: Project#+Contract#. This populates this folder with a database file containing only that projects information. The project is ready for the inspector to Hot Sync to his Laptop

Steps done by the Inspector:

Activate the Dial-Up Network Connection to the Fire Wall Server

Activates the Upload/Download Menu

Select the New Project from a pull down list

Select the Receive Button to hot sync the laptop computer

This downloads the project specific database created by the estimator. The inspector creates is Daily Field Journal for that day

Activates the Upload/Download Menu

Select the Project from a pull down list and the day or range of days for the field journals to upload

Select the Send Button

This uploads only the information that change for that day or range of days selected to the Dial-Up Server

This completes the hot sync process by the inspector

Steps done by the Estimator/DB Administrator

The Estimator now updates the master database with the current project information

Activates the Upload/Download Menu

Selects a Project or Multiple Projects for that day or range of days to update the master database

Selects the Receive Button to hot sync the master database

Once the daily project folders have been updated, an administrator of the database takes each project and uploads the folders to the master database that includes information for all the projects. Once data has been collected, a variety of reports can be generated, including a periodic report such as a monthly report, a progress report, a payment report, an estimate report relating to various aspects of contractor payments. Thus, project managers and administrators can have timely access to information for all projects. Old projects are moved to an archive projects database, which stores static data that is not actively accessed. Data stored in the archive can be imported back into the database for review if needed.

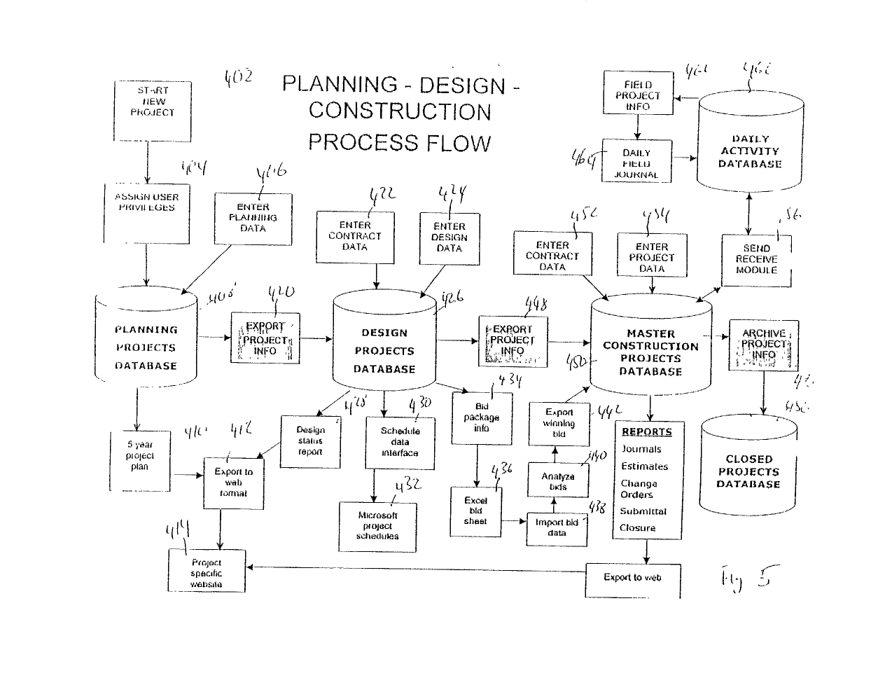

FIG. 5 shows a planning/design/construction process. First, a new project is started (step 402). Next, various user privileges are assigned (step 404) and planning data is entered (step 406) into a planning projects database 408. The information stored in the project database can be can be used to generate a capital improvement plan (step 410) and can be exported into a web-accessible format (step 412) and placed on a project-specific web site (step 414).

Additionally, the information stored on the planning project database can be exported (step 420) as a project information to a design projects database 426. The design projects database can receive contract information (step 422) as well as design information (step 424). The design project database can generate a design status report (step 428) which can be exported to the web format (step 412) for placement on the project specific website (step 414). Additionally, information from the design project database can be provided to a schedule data interface (step 430) that provides output compatible to one or more project schedulers such as Microsoft Project, among others (step 432). Further, the output from the design project database can be provided to a bid package information module (step 434), which in turn can be used in a spreadsheet for contractors to submit cost values on the contract bid items (step 436). This data can be imported (step 438) and analyzed (step 440) and provided to a winning bid export file (step 442). The winning bid output can then be provided to a master construction projects database 450. The master construction projects database can also directly receive project information from the design projects database (step 448).

The master construction projects database 450 can receive contract data (step 452), project data (step 454), and can also send and receive information (step 456) from a daily activity database 460. The daily activity database 460 handles field project information (step 462) as well as daily field journal information (step 464). The output of the master construction database 450 can also be archived as an archive project information module (step 47-) in a closed projects database 480.

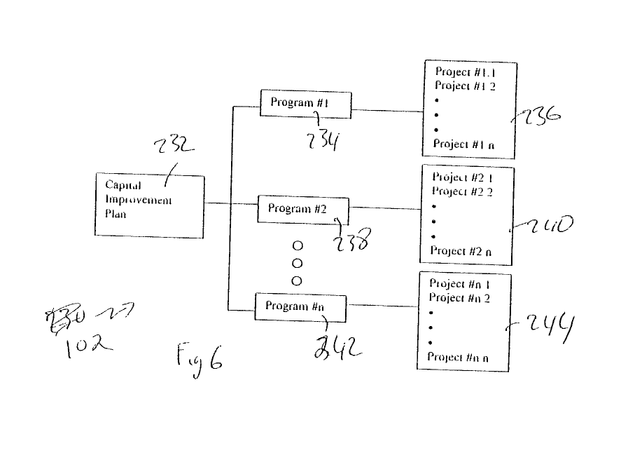

Referring now to FIG. 6, the planning system 102 is shown in more detail. The planning system 102 manages the long term planning for program management of budgets, funding, and schedules. This long term planning information is the core information used in municipalities and agencies Capital Improvement Plans (CIPs). The planning system 102 includes a module for handling capital improvement plan 232 that can be used to provide decision support for municipalities. For example, a owner or agency can have a five-year capital improvement plan. The owner or agency can categorize different elements in that plan. For example, one may be involved with the parks and recreation program, one may be involved with the fire program, and one may be involved with the street and bridge program.

The capital improvement plan module 232 communicates with a plurality of program modules 234, 238, and 242. Further, the program module 234 stores information 236 associated with the first project. Similarly, the program module 238 stores information 240 associated with the second project, and module 242 stores information 244 associated with the Nth project. This structure allows for summary roll-up reports at he project, program, and CIP level.

The planning system 102 includes a Fund/Source Module that maintains multi-year budget plans for the overall CIP process. This allows program managers to create a multiyear Capital Improvement Plans and track the funding sources by program, fund, and by source. Each CIP plan is controlled separately to maintain a historical record of the previous year's CIP plan. This Planning System controls and manages the data associated with this process.

The Design System manages the document control process for design process. This system contains various modules that provide the PCS funtions from Design Contract Award to Construction Contract Award. The following are the modules and the sections below will describe how each Design System module controls the design information by performing documentation control of design information for each individual their projects:

Design Contract Award Phase Module

Design Phase I Module

Design Phase II Module

Design Review Module

Post Advertisement to Bid Phase Module

Post Bid to Construction Contract Award Module

Phase I spans the time where a user has awarded a contract to a particular design or architectural firm to preliminarily design the project. Phase II spans the time required to perform a complete design where construction details are defined. For instance, if the user is building a building, the Phase I design includes performing a site layout. Phase II Design would be what the user wants an atrium area to look like inside, for example. Phase II would also then specify all the structural details, for example the cabinets and the doors, and the result of Phase II a very detailed design specification.

The software is customizable to the individual user by developing templates that resemble a client's existing forms. These modules are all follow the software design architecture and allow the user to select a forms from a dialog box list. This launches the appropriate input window to appear so the user can view and update the design information as required.

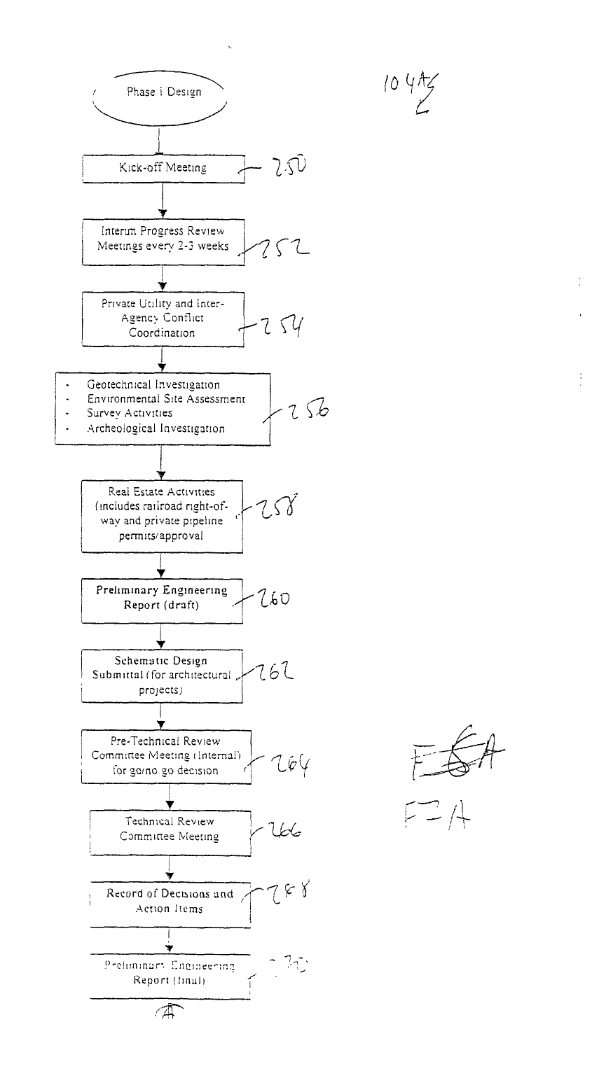

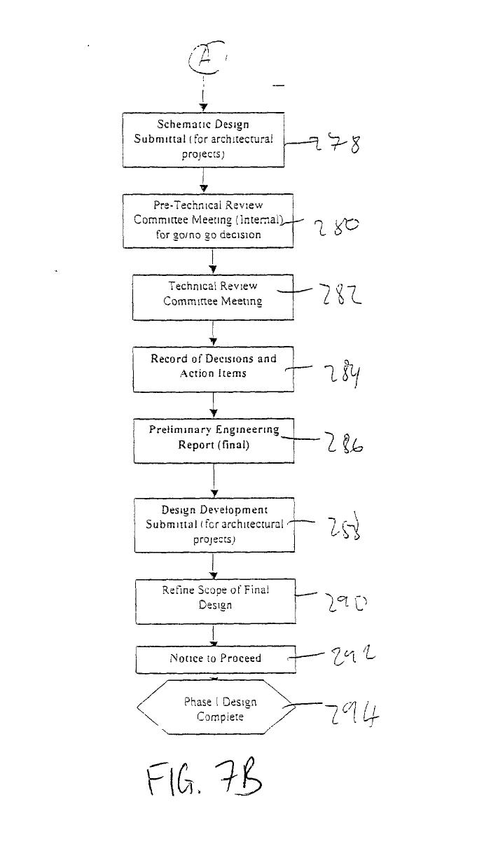

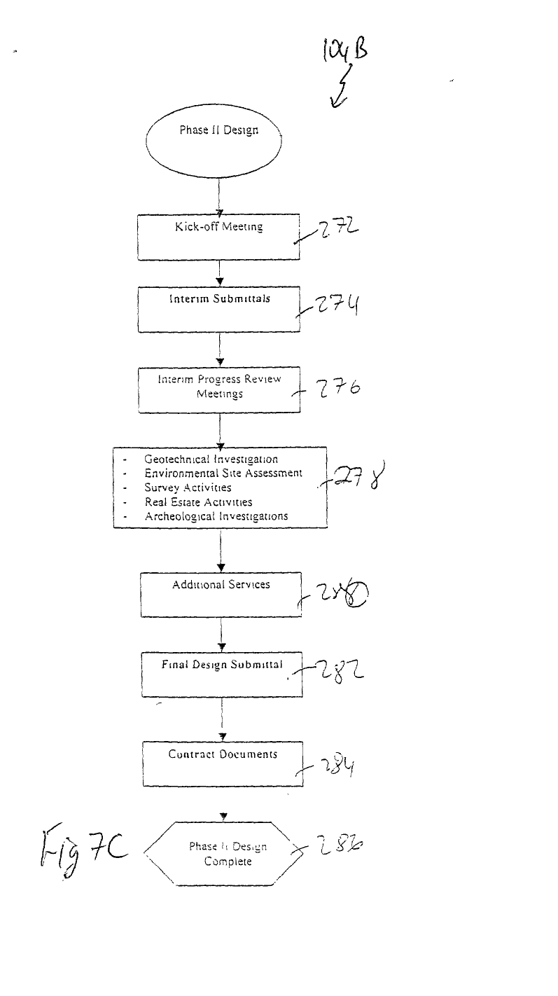

Referring now to FIGS. 7a, 7b and 7c, operations associated with the design module 104 is shown. In FIG. 7a, a meeting is initiated (step 250). Next, interim progress reviews are periodically performed, for example, every two to three weeks (step 250). Next, conflicts between the private utility and various governmental agencies are coordinated (step 254). In step 256, various investigations are performed. The investigations include geotechnical investigations, environmental assessments, survey activities and archeological investigations. Next, the process of FIG. 7a analyzes the real estate activities associated with the design. These activities include railroad right of way and private pipeline permits (step 256). Next, a preliminary engineering report is drafted (step 260). A schematic design is submitted (step 262). A pretechnical review is performed (step 264-266). The decisions and action items of the technical review are captured (step 268), and a preliminary engineering report is finalized (step 270).

From step 270, a schematic design is generated and submitted for the architectural project (step 278). Next, another pretechnical review meeting is held (step 280-282). The records of the decisions and action items associated with a technical review committee meeting are stored (step 284). A preliminary engineering report is then generated (step 286). The design development submittal is then sent (step 288). The scope of the final design is refined (step 290). Finally, the project receives a notice to proceed (step 292) before the phase one of the design is deemed to be completed (step 294).

Phase I Design Module manages the documentation associated with the following fifteen (15) phases of this process. The flowchart on the following page illustrates the Phase I Design process.

1. Kick-Off Meeting

a. Estimate for Payment

b. Design Consultant Memorandum—Action Item Completion

2. Interim Progress Review Meetings

a. Design Consultant Memorandum—Action Item Completion

3. Private Utility and Other Agency Conflict Resolution

a. Documents in this phase are generated by Design Consultant (DC) this phase is mainly to resolve any private utilities conflicts which could be potential construction conflicts

4. Geotechnical Investigation

a. Authorization to Initiate Geotechnical Investigation

b. Geotechnical Report

5. Environmental Site Assessment

a. Authorization to Initiate Phase I Environmental Site Assessment

b. Phase IA ESA Report

6. Survey Activities

a. Authorization to Initiate Survey Work

7. Real Estate Activities

a. Authorization to Initiate Real Estate Activities

b. Real Estate Information Package

8. Archeological Investigation

a. Document reference location information only

9. Other Additional Services

a. Authorization to Initiate Additional Service

10. Preliminary Engineering Report (Draft)

a. Document reference location information only

11. Pre-Technical Review Committee (TRC) Meeting

a. Document reference location information only

12. Technical Review Committee (TRC) Meeting

a. Technical Review Committee Meeting Announcement

b. Technical Review Committee Meeting Agenda

c. Technical Review Committee Meeting Project Summary

d. Record of Decisions and Action Items from TRC Meeting

13. Preliminary Engineering Report (Final)

a. Document reference location information only

14. Contract Amendment or Supplemental Appropriation

a. Professional Scope of Service/Fee

b. If changes accepted than appropriate steps need to be followed for Authorization

c. Package, Contract and Ordinance, and Award and Execution of Design Consultant Contract

15. Notice to Proceed (NTP) for Phase II Design

Referring now to FIG. 7c, Phase II of the design process is shown. First, a meeting is kicked off (step 270). Next, interim submittals are generated (step 274). The interim progress review meetings are held to review the interim submittals (step 276). Next, various investigations are performed (step 278). These investigations include geotechnical investigations, environmental site assessments, server activities, railroad activities and/or archeological investigations.

From step 278, additional operations are performed (step 280). The final design submittal is generated (step 282) and finalized contract documents are generated (step 284) before the Phase II design is completed (step 286).

Phase II Design module manages the documentation associated with the following eleven (11) phases of this process. The flowchart on the following page illustrates the Phase II Design process.

1. Kick-Off Meeting

a. Record of Decision and Action Items (RDAI)—Action Item Completion

2. Interim Progress Review Meetings

a. Record of Decision and Action Items (RDAI)—Action Item Completion

3. Interim Milestone Submittals

a. Document reference location information only

4. Private Utility and Other Agency Conflict Resolution

a. Design Consultant Internal Activities

5. Additional Geotechnical Investigation

a. Authorization to Initiate Additional Geotechnical Investigation

6. Phase II Environmental Site Assessment (ESA)

a. Authorization to Initiate Phase II Environmental Site Assessment

7. Survey Activities

a. Authorization to Initiate Survey Activities

8. Real Estate Activities

a. Authorization to Initiate Real Estate Activities

9. Additional Archeological Investigation

a. Authorization to initiate Additional Archeological Investigation

10. Other Additional Services

a. Authorization to Initiate Other Additional Services

11. Final Design Documents

a. Construction Drawings, Completed Project Manual, Estimate of Construction Cost, Geotechnical Report, Final Engineering Design Report, Completeness Checklist

Phase II Design Review Module manages the documentation associated with the following eleven (11) phases of this process. The flowchart on the following page illustrates the Final Design Review process.

1. Contract Project Director (CPD) Plan Review

a. Document reference location information only—DC submits final design plans to CPD and PM staff

2. Owning Division/User Agency Review

a. No Documentation

3. Constructability Review

a. No Documentation

4. Front-End Documents

a. Form 00010—Project Information Form (C)

b. Document 00800—Supplementary Conditions guide (C)

c. Division 00—Bid Documents—refer to attached page of all bid documents that need to be submitted

d. Division 01—General Requirements

e. The purpose of this phase is to develop a package which will consist of Bid Documents, General Requirements, and basic correspondence for the Project Manger to review

5. Bid-Ready Documents

a. No documentation—documents from previous step are reviewed once more and after review the front-end documents are placed into construction documents

6. Code Enforcement Review for Building Permit (if required)

a. Commercial Building Permit Application

7. Private Utility Signatures and Other Agency Approvals (if required)

a. No documentation

8. Authorizing Signatures

a. No documentation—purpose is for all bid-ready documents for project to be approved by owner or agency

9. Request for Advertisement

a. Advertisement for Bids

b. Request for Advertisement

10. Production of Bid-Ready Documents

a. Plan Holder's List

11. Advertisement for Bids

a. No documentation—purpose is to advertise in the newspaper for bids

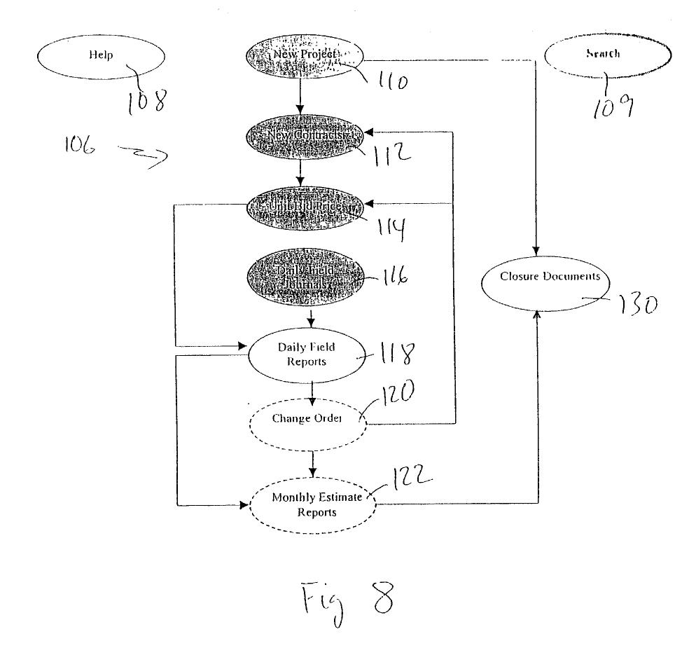

Referring now to FIG. 8, various modules associated with the construction system 106 are shown. First, the help module 108 is provided. Next, a new project launch 110 receives new projects being opened. The new project module is the first module that needs to have user input before any other module will function. This module will consist of the project information table. The new project will have an input field for project name and project number. The project number is critical since the database will key of this number to link other related data tables. Other input fields that will be needed for this module are funding number, funding source, drawing number, key map number, area, and council district. The primary data table that the new project table will be interfacing with is the contract information data table.

The new project module 110 communicates with a new contract module 112. The new contract module will define the contract information for the project. The module will consist of a contract information data table, contractor information data table, contractor affidavit data table. This module will receive project data from the new project information table. The new contract module will have an input field for the contractor number and contractor name, which will be the primary fields. The contract information will also consist of the unit bid contract, which will define the unit price for each item needed for the project along with its planned quantity. The other input fields will consist of contractor id, contract date, contract amount, contract days, ordinance number, gfs number, contractor name, and contract start date.

The new contracts module 112 in turn communicates with a bid price module 114. The Unit Price Bid Contract Module imports the winning construction contractor bid tabulation information. This Bid Tab will be used in by inspectors to track the actual quantities delivered and computation of the contractors earned value will be performed.

The unit bid price module 114 communicates with a daily field report module 118. This is an output module that will create the daily posting report. This module will be linked and take input from the three data tables described in the Field Journal Module. The major items that will be queried from the data tables and presented in the daily posting report are the item number, location of where the work is being done, description of the type of work, the actual quantity of that item used for that day, a cumulative total of the quantity used for that month including that day, the total quantity used for the entire project including that day, the percentage complete and unit price. The formula required to calculate the cumulative total of quantity utilized for the month is shown in equation 1. and the calculation used to determine the total quantity used for the project is shown in equation 2. Equation 3 shows the formula needed to calculate the percentage work complete.

Quantity_Actual=Quantity of Item per day (Equation 1)

Cumul_{—}QTY=Σ(Quantity_Actual's) (Equation 2)

% Work Compete=(Plan_{—}QTY−Cumul_{—}QTY)/Plan_{—}QTY (Equation 3)

A print function will be needed in this module to print out the daily posting report in MS Word format in which the necessary data will be inputted into a defined template.

In addition, a daily field journal 116 communicates with the daily field reports module 118. This module will consist of four data tables, which are the daily work progress table, daily equipment table, daily labor force table and submittal table. The user-input fields for the daily work progress table will include the project number, contract number, report date, item number, and actual quantity. The input fields for the daily equipment table will consist of equipment quantity, hours in use, standby hours, site location, and work type. The input fields for the labor will contain manpower, hours and work type. The submittal table will consist of the submitters' names and the weather for that day. All four data tables will be linked using the project number and contract number. This module can be run as a standalone module by the inspector's laptop to connect to a dial-up server. Once the dial-up server connection is established, the send/receive menu allows for uploads and downloads of selected projects.

The daily field reports module 118 can communicate with a monthly estimate report module 122. This module is also an output module that will basically combined the totals from the daily field reports for each month at the project cutoff date and print a report. The report will consist of each item for the project along with its unit, planned quantity for the entire project, quantity used for the month and quantity used for the entire project through the cutoff date. These items will queried from the daily field report tables monthly. The report will also contain the unit price, total amount spent for each item and cumulative total for all items. The unit price information is defined in the new contract information table and this table will be linked to that table using the contract and project number. The equation to determine the total amount spent on each item to date and cumulative totals are depicted in equation 4 and 5 respectively.

Item Total Amount to Date=Σ(Quanity_Actual)*Unit Price (Equation 4)

Item Cumulative Totals=Cumul_{—}QTY*Unit Price (Equation 5)

A print function will be needed in this module to print out the daily posting report in MS Word format in which the necessary data will be inputted into a defined template.

The monthly estimate report module 122 in turn communicates with a document closure module 130. This module function is to develop all the closure documents that are required for project completion. Individual templates will be created for each document. The appropriate tables for each document will queried to fill out each template. The templates will be created in MS Word format. The closure document templates that will need to be created are listed below.

Final Payment Certificate

Change Orders

Consent of Surety Letter from Contractor

Contractors Certificate of Final Completion

Copy of Approved Council Motion

Affidavit of Work Performed

Each user of the software package will have their own user-defined documents or forms. These documents are user configurable by updating or adding new templates can be created using MS Word depending on the company's requirements without requiring a software source code change.

The daily field reports modules 118 can communicate with a change order module 120 in the event changes are required. If so, the change order module 120 communicates with the unit bit price 114 and the new contract module 112. The requirements for this module are to allow changes to be made to the initial contract. The module will be linked to the new contract table and allow the user to make a change to the original contract. A change order has to go through certain before it is approved. This module will generate the proper documents needed for the change order such as the request for information (RFI), request for proposal (RFP), and the actual change order document. The change order tables will be linked by contract number to extract the appropriate contract information needed for the forms. The change order table will also need to be linked to previous change order (CO) tables to allow the user to know what previous changes have been made to the contract. The fields that will be inputted into the change order tables are the amount and duration of the current change order along with the date that the change order is submitted. This module will then calculate the total amounts of the previous change orders based on equation 6 and previous time extensions based on equation 8. Further, the module will also calculate the revised contract price and revised schedule using equations 7 and 9.

APCO=Σ(Previous Contract Change Orders) (Equation 6)

Revised Contract Price=Original Contract Price+APCO+Current CO Amount (Equation 7)

PTE=Σ(Previous Time Extensions) (Equation 8)

Revised Schedule=Original Contract Duration+PTE+Current CO Extension (Equation 9)

In addition, a search module 109 is provided to assist users in locating documents when necessary.

The main function of this module is to determine the project status based on the project's key indicators. This module is for output there will be no inputs. This module will be linked to the project information table, contract information table, and the estimate tables for each project. This module will query the latest information from these tables to determine if the project is ahead of time, on time, or behind. This will done by looking at the percentage of work completed against actual days used to complete the work using equation 10.

% WKComp=Σ(Item Cumulative Totals)/Revised Contract Price*100 (Equation 10)

This module will create an summary output table which will include the project name, gfs number, contract name, contract number, contractor, contract date, contract amount, contract days, work complete, number of days used, amount paid, percent of total amount paid (equation 11), and lagging indicator (Equation 12).

% By Time=Days Used/Revised Schedule*100 (Equation 11)

% Lagging=% WKComp−% By Time (Equation 12)

The main function of this Schedule Module module is to track the schedule for each bid tabulation item. The user interface controls the start and finish dated for each item. This module provides an interface to MS Project™ that automatically launches, transmits the item description, start date, and finish date to display the project schedule.

The main function of this Send/Receive Data Module module is to control the Daily Field Journal data from the Master Database. This module allows the inspectors using Inspect-IT and the estimators using Construct-IT to manage these Daily Field Journal Updates. Before activating the Send/Receive Data Module, the user will need to dial-up or connect to the project database server. The user selects the project and the date for which these updates are to be performed, and select the appropriate Send or Receive button for the transition required.

The main function of this module is to control user access and update privileges to the content of the Master Database. This module assumes four (4) user types: Inspector, Estimator, Project Manager, and Database Administrator. In addition, this module allows the Database Administrator to configure the users privileges based on a project by project and department by department basis. In general, the Database Administrator would configure the system to allow the following privileges:

Inspector: Daily Field Journal (Read/Write)

Estimator: Daily Field Journal (Read)+Monthly Estimate Report Module (Read/Write)

Project Manager: Main Modules (Read/Write/Update)

Database Administrator: (Full Control)

There will be a help button in the main window. The help with give a complete overview of how the program works and how all the modules are interrelated. Moreover, the help will consist of descriptions of the different functions of the software package. The help will also give a description of each button and its purpose. In addition to the help button that appears in the main window, help on the individual modules will be available. The help on the individual modules will describe the input fields for each module along with the function and use of the module.

A search function will allow the user to search for a particular item in the database. The search will consist of selecting a project or contract and then searching for a particular item associated with that particular contract or project. The search will have to be linked to both the project and contract tables through their project number and contract number to allow the user to find a particular data item in the database.

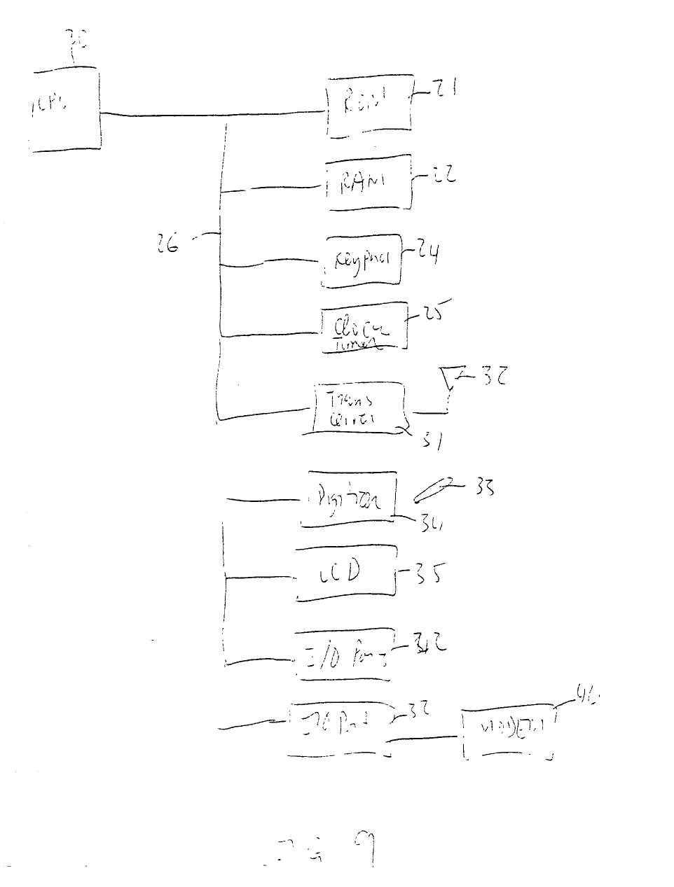

FIG. 9 illustrates an exemplary handheld computer system for collecting and managing construction data. The computer system is preferably housed in a small, rectangular portable enclosure. Referring now to FIG. 9, a general purpose architecture for entering information into the data management by writing or speaking to the computer system is illustrated. In FIG. 9, a processor 20 or central processing unit (CPU) provides the processing capability for the sketching system of the present invention. The processor 20 can be a reduced instruction set computer (RISC) processor or a complex instruction set computer (CISC) processor. Preferably, the processor 20 is a low power CPU such as the MC68328V DragonBall device available from Motorola Inc.

The processor 20 is connected to a read-only-memory (ROM) 21 for receiving executable instructions as well as certain predefined data and variables. The processor 20 is also connected to a random access memory (RAM) 22 for storing various run-time variables and data arrays, among others. The RAM 22 is sufficient to store user application programs and data. In this instance, the RAM 22 can be provided with a back-up battery to prevent the loss of data even when the computer system is turned off. However, it is generally desirable to have some type of long term storage such as a commercially available miniature hard disk drive, or non-volatile memory such as a programmable ROM such as an electrically erasable programmable ROM, a flash ROM memory in addition to the ROM 21 for data back-up purposes. The RAM 22 stores a database of the spreadsheet of the present invention, among others.

The computer system 10 of the present invention has built-in applications stored in the ROM 21 or downloadable to the RAM 22 which include, among others, an appointment book to keep track of meetings and to-do lists, a phone book to store phone numbers and other contact information, a notepad for simple word processing applications, a world time clock which shows time around the world and city locations on a map, a database for storing user specific data, a stopwatch with an alarm clock and a countdown timer, a calculator for basic computations and financial computations, and a database for storing collected construction data. Additionally, project planning tools, and CAD/CAM systems, Internet browsers, among others, may be added to increase the functionality of portable computing appliances. Users benefit from the software, as the software allow users to be more productive when they travel as well as when they are in their offices.

The computer system of the present invention receives instructions from the user using one or more switches such as push-button switches in a keypad 24. The processor 20 is also connected to a real-time clock/timer 25 which tracks time. The clock/timer 25 can be a dedicated integrated circuit for tracking the real-time clock data, or alternatively, the clock/timer 25 can be a software clock where time is tracked based on the clock signal clocking the processor 20. In the event that the clock/timer 25 is software-based, it is preferred that the software clock/timer be interrupt driven to minimize the CPU loading. However, even an interrupt-driven software clock/timer 25 requires certain CPU overhead in tracking time. Thus, the real-time clock/timer integrated circuit 25 is preferable where high processing performance is needed. The expansion bus 26 can communicate with the camera 5, which can be a camera with a charge-coupled device (CCD) image sensor or a CMOS-based image sensor.

Additionally, the expansion bus 26 can receive a wireless transceiver 31, which is connected to an antenna 32. The wireless communication device 31 satisfies the need to access electronic mail, paging, mode/facsimile, remote access to home computers and the Internet. One simple form of wireless communication device 31 is an analog cellular telephone link where the user simply accesses a cellular channel similar to the making of a regular voice call. However, the transmission of digital data over an analog cellular telephone network can give rise to data corruption. Digital wireless networks such as cellular digital packet data (CDPD) can be used. CDPD provides data services on a non-interfering basis with existing analog cellular telephone services. In addition to CDPD, a communication service called Personal Communication Services (PCS) allows wireless access into the public service telephone network.

The two-way communication device 31 can also be a two-way pager where the user can receive as well as transmit messages. The two-way communication device supports a Telocator Data Protocol by the Personal Communications Association for forwarding binary data to mobile computers. The standard facilitates transmission of images and faxes over paging and narrowband PCS networks. Alternatively, the two-way communication device 31 can be substituted with a cellular telephone.

The two-way communication device 31 has a receiver, a transmitter, and a switch, all are controlled by the CPU 20 via the bus of the portable computer system of FIG. 1. The switch receives an input from the antenna 32 and appropriately routes the radio signal from the transmitter to the antenna 32, or alternatively, the radio signal from the antenna 32 to the receiver in the event the processor 20 is expecting a message. Via the bus 26, the processor 20 controls the receiver, the transmitter, and the switch to coordinate the transmission and receipt of data packets. The receiver and transmitter are standard two-way paging devices or standard portable cellular communication chips available from Motorola, Inc. in Schaumburg, Ill. or Philips Semiconductors in Sunnyvale, Calif. The antenna 32 is preferably a loop antenna using flat-strip conductors such as printed circuit board wiring traces as flat strip conductors have lower skin effect loss in the rectangular conductor than that of antennas with round-wire conductors.

The processor 20 of the preferred embodiment accepts handwritings as an input medium from the user. A digitizer 34, a pen 33, and a display LCD panel 35 are provided to capture the handwriting. Preferably, the digitizer 34 has a character input region and a numeral input region which are adapted to capture the user's handwritings on words and numbers, respectively. The LCD panel 35 has a viewing screen exposed along one of the planar sides of the enclosure are provided. The assembly combination of the digitizer 34, the pen 33 and the LCD panel 35 serves as an input/output device. When operating as an output device, the screen 35 displays computer-generated images developed by the CPU 20. The LCD panel 35 also provides visual feedback to the user when one or more application software execute. When operating as an input device, the digitizer 34 senses the position of the tip of the stylus or pen 33 on the viewing screen 35 and provides this information to the computer's processor 20. In addition to the vector information, the present invention contemplates that display assemblies capable of sensing the pressure of the stylus on the screen can be used to provide further information to the CPU 20.

The preferred embodiment accepts pen strokes from the user using the stylus or pen 33 which is positioned over the digitizer 34. As the user “writes,” the position of the pen 33 is sensed by the digitizer 34 via an electromagnetic field as the user writes information to the data management computer system. The digitizer 34 converts the position information to graphic data that are transferred to a graphic processing software of the data logger computer system. The data entry/display assembly of pen-based computer systems permits the user to operate the data logging computer system as an electronic notepad. For example, graphical images can be input into the pen-based computer by merely moving the stylus over the surface of the screen. As the CPU 20 senses the position and movement of the stylus, it generates a corresponding image on the screen to create the illusion that the pen or stylus is drawing the image directly upon the screen. The data on the position and movement of the stylus is also provided to a handwriting recognition software, which is stored in the ROM 21 and/or the RAM 22. The handwriting recognizer suitably converts the written instructions from the user into text data suitable for saving time and expense information. The process of converting the pen strokes into equivalent characters and/or drawing vectors using the handwriting recognizer is described below.

Preferably, the handwriting recognizer of the present invention recognizes non-cursive characters in a fixed style using a basic character set, preferably a 36-character alphanumeric character set. In addition to the basic 26 letters and 10 digits, the non-cursive handwriting recognizer includes multi-step pen strokes that can be used for punctuation, diacritical marks, and capitalization. Preferably, the non-cursive handwriting recognizer is a software module called GRAFFITI, commercially available from Palm Computing, Inc. Each letter in the non-cursive alphabet is a streamlined version of the standard block character—the letter A, for example, looks like a pointy croquet hoop, and the hoop must be started at the dot indicator at the lower right corner—as illustrated and discussed in more detail in the above incorporated-by-reference U.S. patent applications. By restricting the way the user writes, the non-cursive handwriting recognizer achieves a more perfect recognition and, as with stenography, supports an alphabet consisting of characters that can be written much more quickly than conventional ones.

The computer system is also connected to one or more input/output (I/O) ports 42 which allows the CPU 20 to communicate with other computers. Each of the I/O ports 42 may be a parallel port, a serial port, or alternatively a proprietary port to enable the computer system to dock with the host computer. In the event that the I/O port 42 is housed in a docking port 84, after docking, the I/O ports 42 and software located on a host computer 82 support an automatic synchronization of data between the computer system and the host computer. During operation, the synchronization software runs in the background mode on the host computer 82 and listens for a synchronization request or command from the computer system 10 of the present invention. Changes made on the computer system and the host computer will be reflected on both systems after synchronization. Preferably, the synchronization software only synchronizes the portions of the files that have been modified to reduce the updating times.

The I/O port 42 is preferably a high speed serial port such as an RS-232 port, a Universal Serial Bus, or a Fibre Channel for cost reasons, but can also be a parallel port for higher data transfer rate. Preferably, the I/O port 42 has a housing which is adapted to snappably connect to the housing of a Musical Instrument Digital Interface (MIDI) player 37, a fax modem 40, a voice recorder 43, a GPS receiver 46 and a barcode reader 48. When the I/O port 42 is connects to the MIDI player 37, the computer system 10 drives high quality audio speakers 38 and 39 which connect to the MIDI player 37 to support multimedia applications on the computer 10.

Additionally, via the serial port 42, a fax-modem 40 is adapted to receive information over a telephone 41 via a plain old telephone system (POTS) landline or over the radio frequencies and allow the user to access information untethered. Further, the modem 40 may serve as part of a wide-area-network to allow the user to access additional information. The fax-modem 40 can receive drawings and text annotations from the user and send the information over a transmission medium such as the telephone network or the wireless network to transmit the drawings/text to another modem or facsimile receiver, allowing the user to transmit information to the remote site on demand. The fax-modem 40 can be implemented in hardware or in software with a few additional components such as a DAA, as is known in the art.

The case is a rectangular plastic casing with a major opening on the top of the case to receive the LCD panel 35 and the digitizer 34. The case has a receptacle which is adapted to receive and store the pen 33. Furthermore, a plurality of push-buttons in the keypad 24 are positioned on the top side of the case. The push-buttons of the keypad 24 preferably allows the user to invoke one or more pre-installed software on the handheld computer. Additionally, the case has an opening on the backside which is adapted to receive a connector carrying the electrical impulses to and from the I/O port 42.

The handheld computer executes software stored in an excutable format such as a prc file. The software allows the handheld computer to track Daily Field Journals, such as:

Work Progress of Unit Bid Items and Contract Deliverables

Manpower Utilization

Equipment Utilization

General Information including weather, temperature, remarks, and inspector's name.

The software also tracks an Inspection Checklist, such as:

Generation of Punch list items

Tracking of Punch list items

Facility Inventory

Facility Repairs & Cost Estimates

The software also keeps Project Documentation and captures, among others:

Project Specifications

Industry Specifications

Drawing Logs

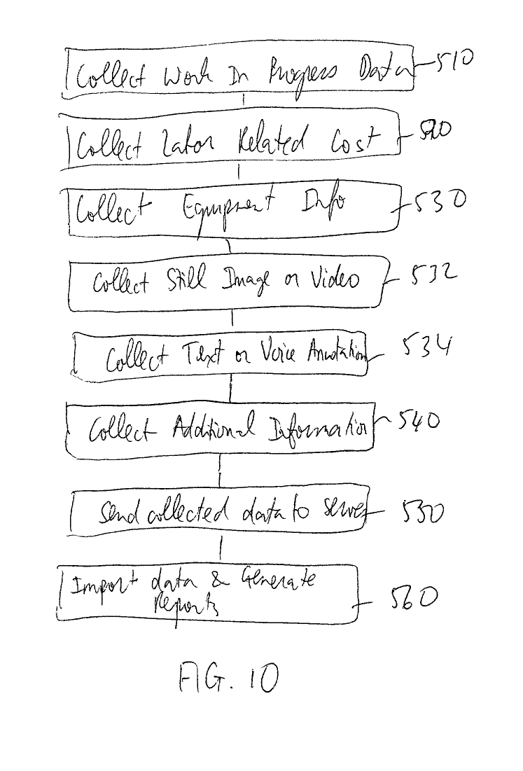

FIG. 10 shows an exemplary process 500 for collecting data in the field and uploading the data to the computer of FIG. 2. First, a user collects work in progress data (step 510). The information collected includes project/contract identification, inspector identification, item number, location, and one or more description of activities. Various exemplary screens on a handheld computer for step 510 are shown as FIGS. 11-18. Next, the user collects labor related cost (step 520). The information collected in step 520 includes labor type, quantity and hours. Next, the process 500 collects equipment being used for the project (step 530). The information collected includes equipment type, quantity, hours in use and stand-by hours. Next, the process 500 collects additional submittal information (step 540). The information collected includes weather condition, comments, and the name of the inspector, among others. The process 500 then sends the collected information to the system of FIG. 1 (step 550). This can be done wirelessly using a wireless handheld unit such as the Palm VII, available from Palm Computing. Alternatively, the information can be transmitted using a modem or using an external computer with a suitable hot-sync cradle. In the later case, the handheld unit is synchronized with the external computer and, upon concluding the synchronization, the external computer opens a connection with the server of FIG. 1 and transmits the collected data from the handheld unit. The collected information is then imported to the database of FIG. 1, and appropriate data import operations and report generation operations can be done (step 560). The process 500 then exits.

After collecting data, the handheld computer is placed in a hot sync cradle or aligned with an infrared port on a host computer for data transfer. The user, or inspector, activates a data receiving software on a workstation or a laptop. The user selects an icon to initiate data uploads and downloads to the handheld computer. The user will select the project to be updated or refreshed before selecting the icon. Only changed project information will be uploaded. The downloading of project information is performed the same way, a project is selected and selection of the icon initiates the file transfer. The file transfer results in the project information stored in a database to be converted to a handheld format such as a “pdb format”. The “pdb format” will result in an individual project table to be generated for each project on the handheld computer. Updates to the table is done in the same manner as described above.

Although an exemplary implementation has been shown for making ground travel reservation covering taxis, limousines, buses, charters, rental cars, shuttles, buses and trains, among others, the system is expandable to other industries. Although the invention has been described with reference to specific embodiments, this description is not to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A field inspection system comprising:
a handheld computer;
a camera coupled to the computer to capture an image or video;
a sketch pad coupled to the handheld computer to capture a sketch; and
code to annotate the image and to communicate the image to a remote computer.

2. The system of claim 1, wherein the handheld computer collects work in progress data.

3. The system of claim 1, wherein the handheld computer collects project and contract identification, inspector identification, item number, location, and one or more description of activities.

4. The system of claim 1, wherein the handheld computer collects labor related information.

5. The system of claim 1, wherein the handheld computer collects labor type, quantity and hours.

6. The system of claim 1, wherein the handheld computer collects equipment information.

7. The system of claim 1, wherein the handheld computer collects equipment type, quantity, hours in use and stand-by hours.

8. The system of claim 1, wherein the handheld computer collects submittal information.

9. The system of claim 1, wherein the handheld computer collects weather condition, comments, and an inspector name.

10. The system of claim 1, wherein the handheld computer sends collected information to a server.

11. The system of claim 10, wherein the collected information wirelessly using a wireless handheld unit.

12. the system of claim 10, further comprising a modem coupled to the handheld computer, wherein the information can be transmitted using a modem.

13. The system of claim 10, further comprising a hot-sync cradle coupleable to the handheld computer, the cradle hot-syncing the collected information for transmission to a server.

14. A method for managing a construction project, comprising:
collecting construction data from the field with a handheld computer;
capturing an image of the construction project using a camera coupled to the handheld computer;
tracking budgetary information using a planning system;
performing site engineering assessment using a design system; and
tracking material consumption and progress for each project using a construction system, the construction system adapted to receive data collected from the handheld computer.

15. The method of claim 14, further comprising collecting work in progress data using the handheld computer.

16. The method of claim 14, further comprising collecting labor related information using the handheld computer.

17. The method of claim 14, further comprising collecting equipment information using the handheld computer.

18. The method of claim 14, further comprising collecting submittal information using the handheld computer.

19. The method of claim 14, wherein the handheld computer collects project and contract identification, inspector identification, item number, location, one or more description of activities, labor type, quantity, hours, weather condition, comments, and an inspector name.

20. The method of claim 14, further comprising sending collected information to a server over land-line or wireless medium.
